(19) United States
(12) Patent Application Publication
(10) Pub. No.: US 2017/0326028 A1
(43) Pub. Date: Nov. 16, 2017

(54) DEVICES TO BE USED FOR ACUPRESSURE

(71) Applicant: Jonathan Reid Doogan, Carlsbad, CA (US)

(72) Inventor: Jonathan Reid Doogan, Carlsbad, CA (US)

(21) Appl. No.: 15/593,289

(22) Filed: May 11, 2017

Related U.S. Application Data
(60) Provisional application No. 62/336,359, filed on May 13, 2016.

(51) Int. Cl. A61H 39/04

(52) U.S. Cl. CPC A61H 39/04; A61H 2205/12; A61H 2205/10; A61H 2201/102; A61H 2205/02; A61H 2201/1607; A61H 2205/065

(57) ABSTRACT

A wearable acupressure device (WAD) is described that may include one or more pockets with one or more beads to apply pressure at various points on the body. The bead may be domed or marble shaped. The WAD may be worn on one or more portions of the body, including the arm, leg, head and foot. Also, the bead may be used for aromatherapy.

This application claims priority to U.S. Provisional Application No. 62/336,359, which application is incorporated herein in its entirety.

### BACKGROUND OF THE INVENTION

### 1. Field of the Invention

This present invention relates to wearable articles that may be used to apply pressure to certain parts of the body, and more particularly, to wearable articles that may be used for acupressure and/or aromatherapy.

### 2. Background

Acupressure therapy is generally based on the teaching of acupuncture in which pressure is applied to the body at an acupuncture point to alleviate pain, bring about healing, and/or treat a medical condition. Acupressure provides significant proven health benefits in relieving chronic pain over parts of the body, migraine headaches, and other ailments. Acupressure also often serves as a complement to other medical regimens.

One significant issue with many acupressure points is that they are located in places that are difficult to access and often require a professional to reach to apply pressure the correct location on the body. Moreover, some pressure points require extended times and amounts of pressure to be applied to be effective.

Accordingly, there is a need for a method, system, and apparatus for applying acupressure through wearable devices.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates different pressure points for a male and female in an example.

FIG. 2 illustrates an example of a wearable headband in an embodiment.

FIGS. 3A and 3B illustrates a wearable headband from different views in an embodiment.

FIG. 4 illustrates various pressure points for a hand in one view.

FIG. 5 illustrates various pressure points for a hand in a second view.

FIG. 6 illustrates a hand band for a hand in an embodiment.

FIG. 7 illustrates a hand band for a hand in an embodiment.

### DETAILED DESCRIPTION

Each of the additional features and teachings disclosed below can be utilized separately or in conjunction with other features and teachings to provide a device, system, and/or method for a wearable acupressure device. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

Devices, methods, and systems are described for a wearable acupressure device (WAD) that may be worn on one or more parts of the body. In one example, the WAD may be a headband, wristband, armband, and/or leg band. It will be understood that embodiments are not limited to any particular style or type of garment or band. Other embodiments may include any WAD that may be worn on the body using the techniques and concepts of the WAD described herein. Also, any type of activity or athletic training technique may be conducted in the WAD.

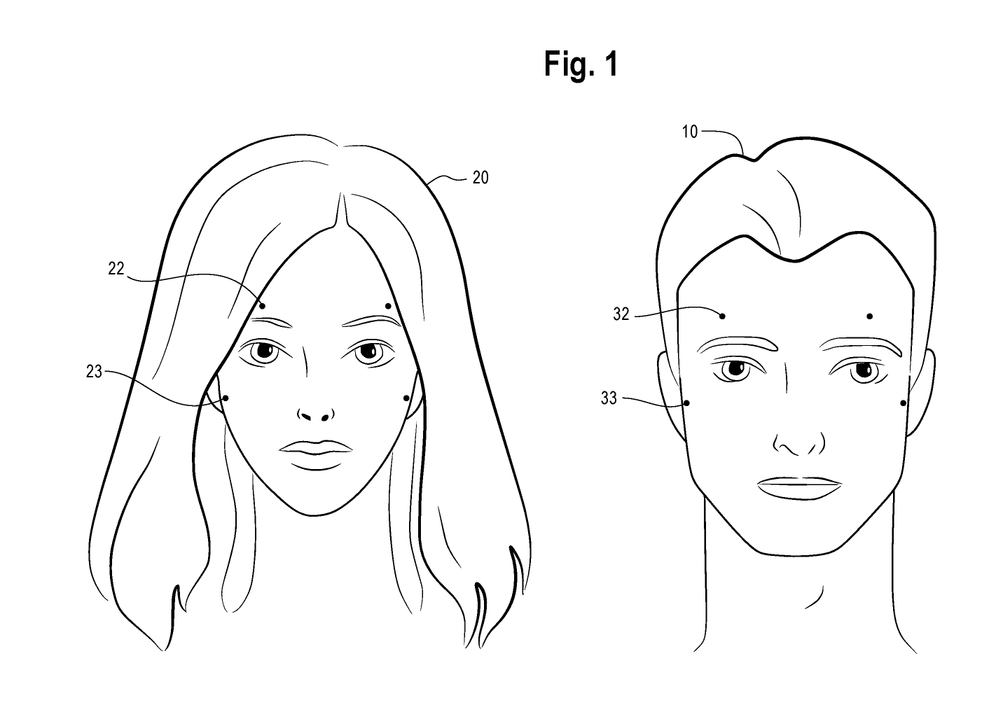

FIG. 1 shows pressure points of a man 20 and woman 10 in an embodiment. The pressure points may include gall bladder 22, 32 and small intestine 23, 33. The gall bladder pressure point may be used to medicate headaches, sinuses, vision, and other eye ailments. The small intestine pressure point may medicate the auditory palace.

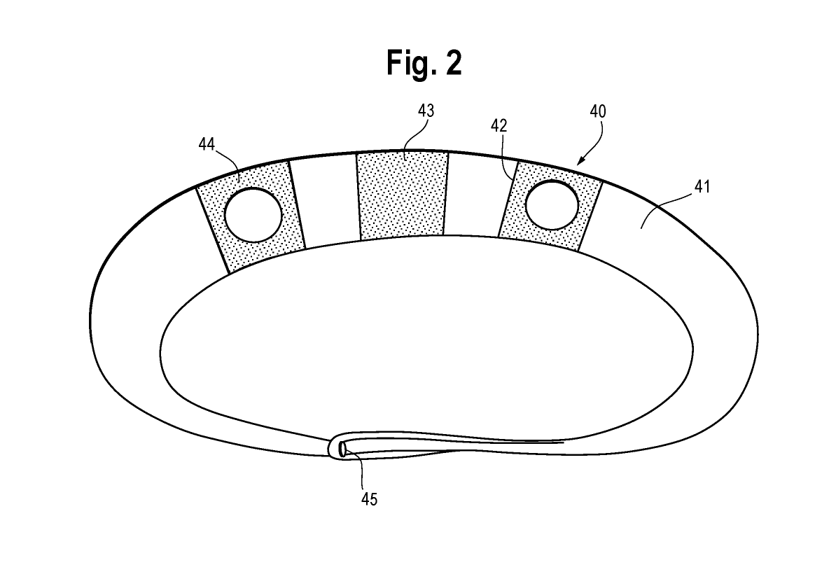

FIG. 2 shows a headband in an embodiment. As shown, the headband 40 may include one or more pockets 42-44 to receive a bead 46 in a shape suitable to apply pressure to the points 22, 32 and 23, 33. The beads may be in the form of a dome in one embodiment. In other embodiment, the bead may take the shape of a marble. In some embodiments, the band 40 may be made from any material comfortable to be secured around the head including polyester, Lycra or neoprene. Additionally, pockets 42-44 may be of such a size and shape to receive the bead 46 and apply suitable pressure to the pressure point. The band 40 may have any number of pockets and beads. In some cases, the beads may be integrated into the band. In other embodiments, the beads may be removable from the pockets. In other embodiments, the beads may be sewn into the pockets.

The band 40 may also include a fastening device 45 in the form of a loop that may be secured by Velcro. The fastening device 45 may also include buttons, snaps, or the like. The bead 46 may be made of cork. In one embodiment, the bead may include the ability to provide or release oils and plant extracts for aromatherapy. In another embodiment, the bead 46 may also be able to emanate heat and provide aromatherapy.

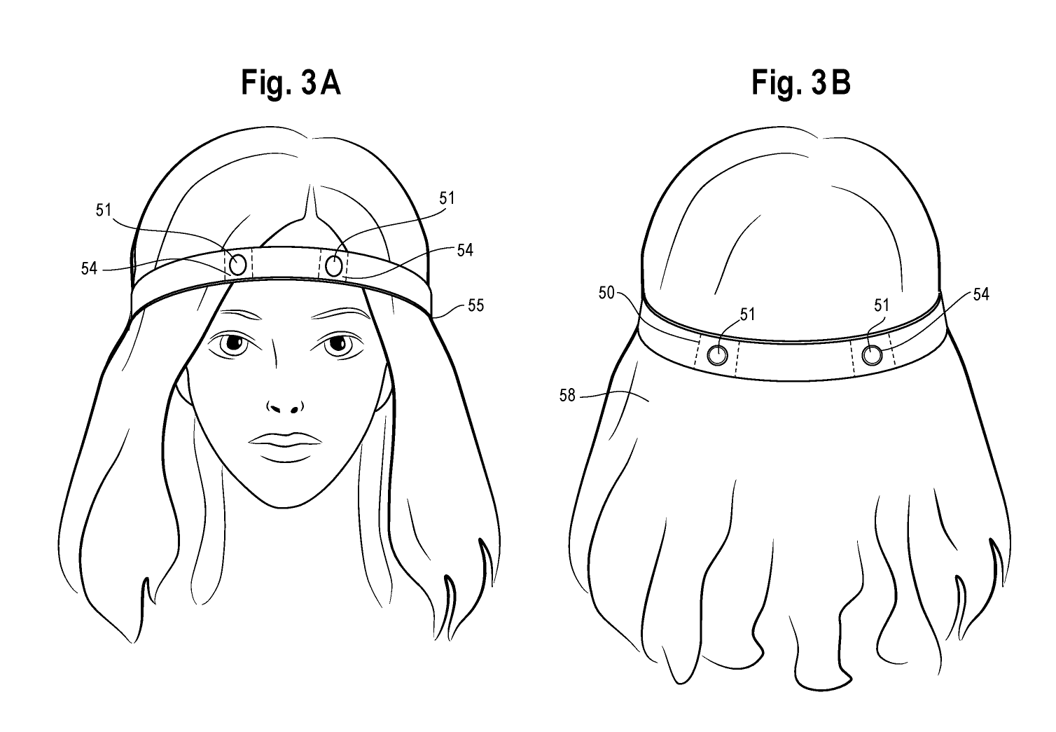

FIGS. 3A-3B shows a headband 50 substantially similar to headband 40 from a back view 58 and a front view. The band 50 may include pockets 54 for receiving beads 51. The pockets 54 may be adjustable to apply pressure at different points along the body. Beads 51 are substantially the same as bead 46 and pockets 51 are substantially the same as pockets 42-44.

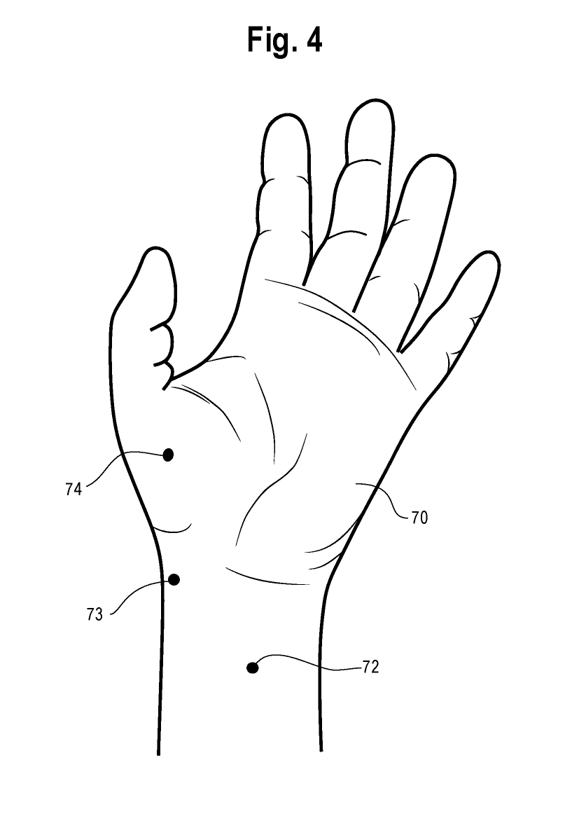

FIG. 4 shows a view of a hand 70 having pressure points pericardium (PC6) 72 which may be used for motion sickness and fatigue, lung 10 (L10) 74 for common cold and breathing problems, heart 7 (H7) 71 sleeping problems and anxiety, and Lung 7 (L7) 73 coughing and respiratory.

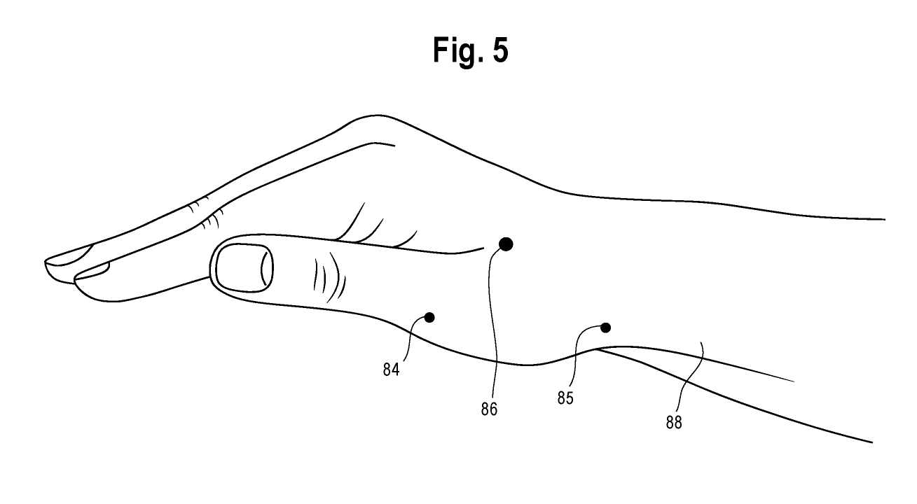

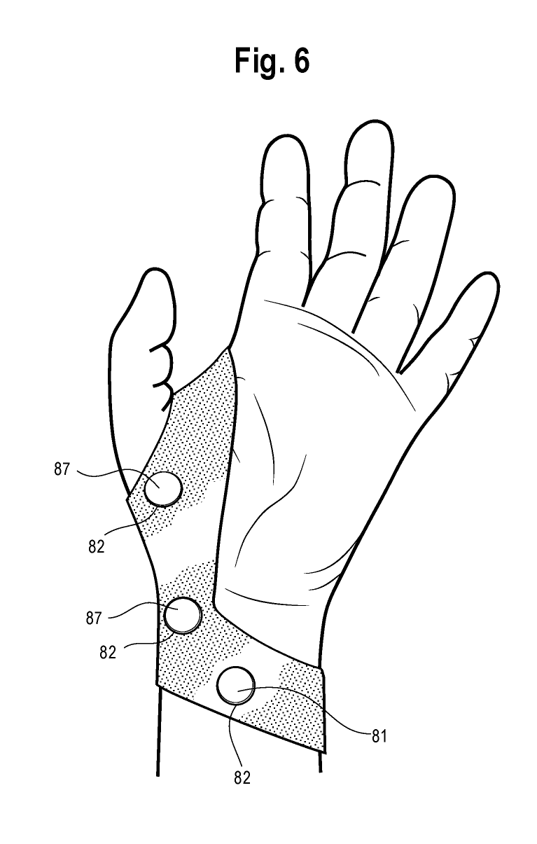

FIG. 5 shows a view of hand 88. In this configuration, there is shown the Lung 9 (L 9) 81 and large intestine 4 (LI 4) 86. FIG. 6 illustrates a hand 80 having substantially the same pressure points of hand 70. As shown, the hand band 81 may include one or more beads 82 that are fit into pockets substantially the same as pockets 42-44 of band 40. Bead 82 is substantially the same as bead 46. In one example, like components of band 81 are substantially the same as band 40. In other embodiments, the band 81 may be slid over the hand 80. In other embodiments, the band 81 may be secured to the hand by Velcro straps. The band 81 may be made of neoprene or polyester or similar material.

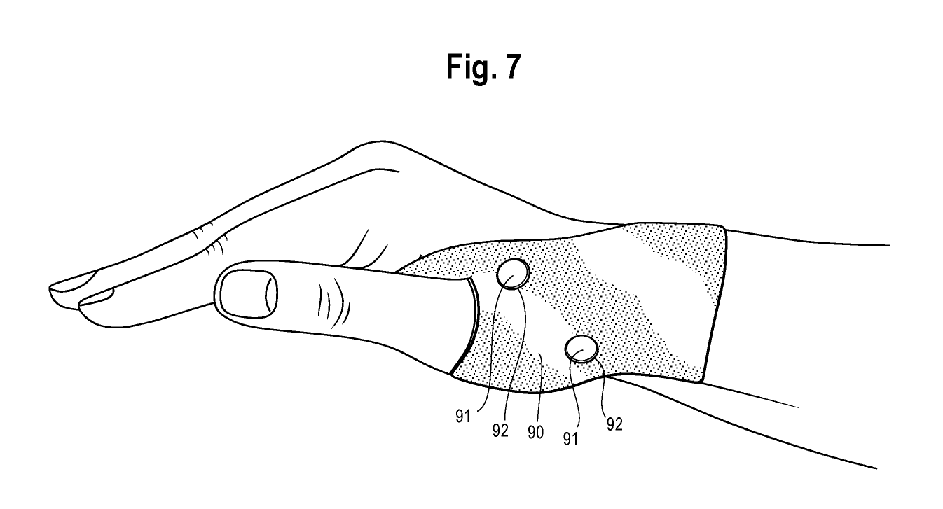

Referring to FIG. 7, there is shown a band 90 around hand 88. As shown, the beads 91 may be applied at pressure points 86 and 85. The beads 91 may be similar to bead 46. In one example, the band 90 may be similar to like components to the band 40. It should be noted that the pressure points that may be used by the WAD may be located anywhere on the body including the arms, legs, back, head, foot, chest or shoulders.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for. . . . ”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A wearable acupressure device (WAD), comprising:
an article configured to apply to a portion of a body;
one or more pockets including one or more beads, the pockets being located at a pressure point of the body and the beads applied to provide acupressure to the pressure point.

2. The WAD of claim 1, wherein the bead is one of dome shaped and marble shaped.

3. The WAD of claim 1, wherein the article is made from one of neoprene, Lycra, and polyester.

4. The WAD of claim 1, wherein the article is configured to apply to one of a hand, foot, leg and head of the body.

5. The WAD of claim 1, wherein the pressure point includes one the small intestine and gall bladder, pericardium (PC6), lung (L10), heart (H7), lung 7 (L7) lung 9 (L 9), and large intestine (LI 4).

6. The WAD of claim 1, wherein bead is configured to provide aromatherapy to the pressure point.

7. The WAD of claim 1, wherein the bead is one of sewn into the pocket and removable from the pocket.

8. The WAD of claim 1 further comprising a fastening device.

9. The WAD of claim 8, wherein the fastening device includes one of a loop secured by Velcro, buttons, and snaps.

10. The WAD of claim 1, wherein the bead emits one of heat and plant and oil extracts to provide the aromatherapy.

11. A wearable acupressure device (WAD), comprising:
an article configured to apply to a portion of a body;
one or more pockets including one or more beads, the pockets being located at a pressure point of the body and the beads applied to provide aromatherapy to the pressure point.

12. The WAD of claim 11, wherein the bead is one of dome shaped and marble shaped.

13. The WAD of claim 11, wherein the article is made from one of neoprene, Lycra, and polyester.

14. The WAD of claim 11, wherein the article is configured to apply to one of a hand, foot, leg and head of the body.

15. The WAD of claim 11, the pressure point includes one the small intestine and gall bladder, pericardium (PC6), lung (L10), heart (H7), lung 7 (L7) lung 9 (L 9), and large intestine (LI 4).

16. The WAD of claim 11, wherein bead is configured to provide acupressure to the pressure point.

17. The WAD of claim 11, wherein the bead is one of sewn into the pocket and removable from the pocket.

18. The WAD of claim 11 further comprising a fastening device.

19. The WAD of claim 18, wherein the fastening device includes one of a loop secured by Velcro, buttons, and snaps.

20. The WAD of claim 11, wherein the bead emits one of heat and plant and oil extracts to provide the aromatherapy.
